(19) United States
(12) Patent Application Publication
(10) Pub. No.: US 2024/0372726 A1
(43) Pub. Date: Nov. 7, 2024

(54) OPERATION METHOD OF ELECTRONIC DEVICES FOR INITIALIZING PASSWORD OF BIOS AND SAME ELECTRONIC DEVICES

(71) Applicant: Samsung Electronics Co., Ltd., Suwon-si (KR)

(72) Inventors: Jungyoon KIM, Suwon-si (KR); Jinmo YANG, Suwon-si (KR); Yooree LEE, Suwon-si (KR)

(21) Appl. No.: 18/776,879

(22) Filed: Jul. 18, 2024

Related U.S. Application Data
(63) Continuation of application No. PCT/KR2023/001952, filed on Feb. 10, 2023.

(30) Foreign Application Priority Data
Apr. 6, 2022 (KR) 10-2022-0043053
May 6, 2022 (KR) 10-2022-0055971

(51) Int. Cl. H04L 9/32; H04L 9/06

(52) U.S. Cl. CPC H04L 9/3226; H04L 9/0618

(57) ABSTRACT

A user terminal is provided. The user terminal includes an input interface configured to receive a user input of requesting initialization of a password of a basic input output system (BIOS) of the user terminal, and receive a decrypted string obtained by decrypting a ciphertext for initialization in response to the initialization request being verified based on verification information from a server, memory storing one or more computer programs, and one or more processors communicatively coupled to the input interface and the memory, wherein the one or more computer programs include computer-executable instructions that, when executed by the one or more processors individually or collectively, cause the user terminal to generate the ciphertext by encrypting a predetermined length of random string in response to the user input, and initialize the password of the BIOS according to whether a second hash value for the decrypted string and a first hash value for the random string match.

### CROSS-REFERENCE TO RELATED APPLICATION(S)

This application is a continuation application, claiming priority under 35 U.S.C. § 365(c), of an International application No. PCT/KR2023/001952, filed on Feb. 10, 2023, which is based on and claims the benefit of a Korean patent application number 10-2022-0043053, filed on Apr. 6, 2022, in the Korean Intellectual Property Office, and of a Korean patent application number 10-2022-0055971, filed on May 6, 2022, in the Korean Intellectual Property Office, the disclosure of each of which is incorporated by reference herein in its entirety.

### BACKGROUND

### 1. Field

The disclosure relates to an operation method of electronic devices to initialize a password of a basic input output system (BIOS) and the electronic devices.

### 2. Description of Related Art

A computer may include hardware, such as a central processing unit (CPU), memory, and input/output units, software, such as an operating system and application programs, and firmware. Firmware may be a component that organically combines hardware and software while having the characteristics of both in a computer. Firmware is a type of control program that is functionally close to software, but seems like hardware as it is located in hardware and a user cannot easily change the contents of the program.

Firmware existing in personal computers (hereinafter, personal computers (PCs)), such as desktops and/or laptops, which are bywords for computers, is called a basic input/output system (BIOS)” and is used to manage input and/or output of basic data.

The above information is presented as background information only to assist with an understanding of the disclosure. No determination has been made, and no assertion is made, as to whether any of the above might be applicable as prior art with regard to the disclosure.

### SUMMARY

In general, PC users may protect their PCs from malicious attacks by setting up login accounts and passwords for an operating system, such as Windows, but such protection may be easily bypassed simply by changing the BIOS settings of the PCs. These attacks may be prevented by allowing only authorized users to change the BIOS password settings. When a password is set for a BIOS of a PC, booting and/or changing BIOS settings may be allowed only if the correct password is input. In this case, since it is impossible to use a PC without knowing the BIOS password, most PC manufacturers and/or service centers may provide password recovery and/or initialization services to a user who has forgotten the password. However, even a malicious attacker may recover the password by figuring out the BIOS password recovery and/or initialization algorithm for each manufacturer, so it is difficult to say it is safe in terms of security.

An embodiment may initialize a PC BIOS password by generating a ciphertext using a public key of a server stored in a user terminal and determining whether it is possible to decrypt the ciphertext using a private key stored in the server.

An embodiment may allow the initialization of a PC BIOS password through a service center by determining whether it is possible to decrypt a ciphertext based on verification information transmitted from the service center, instead of verifying an electronic signature when authenticating the service center.

An embodiment may enable input using various input devices, such as a universal serial bus (USB), a camera, and a quick response (QR) code scanner by converting a ciphertext into a form that can be manually input or a QR code form and outputting the ciphertext.

Aspects of the disclosure are to address at least the above-mentioned problems and/or disadvantages and to provide at least the advantages described below. Accordingly, an aspect of the disclosure is to provide an operation method of electronic devices to initialize password of bios and same electronic devices.

Additional aspects will be set forth in part in the description which follows and, in part, will be apparent from the description, or may be learned by practice of the presented embodiments.

In accordance with an aspect of the disclosure, a user terminal is provided. The user terminal includes an input interface configured to receive a user input requesting initialization of a password of a BIOS of the user terminal, and receive a decrypted string obtained by decrypting a ciphertext for the initialization in response to the initialization request being verified based on verification information from a server, memory storing one or more computer programs, and one or more processors communicatively coupled to the input interface and the memory, wherein the one or more computer programs include computer-executable instructions that, when executed by the one or more processors individually or collectively, cause the user terminal to generate the ciphertext by encrypting a predetermined length of random string, in response to the user input, and initialize the password of the BIOS according to whether a second hash value for the decrypted string and a first hash value for the random string match.

In accordance with another aspect of the disclosure, a server is provided. The server includes a communication interface configured to receive a ciphertext for initialization of a password of a BIOS of a user terminal and verification information to verify the initialization request, memory storing one or more computer programs, and one or more processors communicatively coupled to the input interface and the memory, wherein the one or more computer programs include computer-executable instructions that, when executed by the one or more processors individually or collectively, cause the server to verify the initialization request by comparing the verification information with pre-enrolled information, and generate a decrypted string by decrypting the ciphertext using a prestored private key according to the verification result, wherein the communication interface is configured to output the decrypted string.

In accordance with another aspect of the disclosure, a method of operating a system including a user terminal, a service center terminal, and a server is provided. The method includes receiving, by the user terminal, a user input requesting initialization of a password of a BIOS of the user terminal, generating, by the user terminal, a ciphertext by encrypting a predetermined length of random string using a public key of the server prestored in the BIOS, in response to the user input, transmitting, by the service center terminal, the ciphertext and verification information to verify the initialization request to the server, verifying, by the server, the initialization request using the verification information, outputting, by the server, a decrypted string by decrypting the ciphertext using a prestored private key based on whether the verification is successful, and initializing, the user terminal, the password of the BIOS according to whether a second hash value for the decrypted string and a first hash value for the random string match.

According to an embodiment of the disclosure, it is possible to allow only a user terminal verified by a server to attempt to initialize and/or recover a BIOS password by transmitting a ciphertext for the initialization of the BIOS password along with verification information.

According to an embodiment of the disclosure, it is possible to block attempts of an external terminal other than a manufacturer or a service center to initialize and/or recover a BIOS password by transmitting a ciphertext for the initialization of the BIOS password and verification information through a service center.

According to an embodiment of the disclosure, it is possible to minimize the length of a value to be input into a user terminal having an input device limited compared to an output device, by verifying whether it is possible to decrypt a ciphertext by verification information transmitted by the user terminal and/or a service center, instead of verifying an electronic signature when verifying an initialization request for a BIOS password.

According to an embodiment of the disclosure, it is possible to reduce the possibility of human errors and improve the convenience of a BIOS password initialization task by converting a ciphertext into a form that can be manually input or a QR code form, outputting the ciphertext, and transmitting the converted ciphertext to a server through various input devices, such as, for example, a universal serial bus (USB), a keyboard, a camera, and/or a QR code scanner.

According to an embodiment of the disclosure, it is possible to lower the possibility of attacks by attackers occurring during the process of initializing a BIOS password by exchanging a ciphertext and/or verification information between a server and a user terminal and/or between a server and a service center terminal using a secure communication protocol, such as secure sockets layer (SSL) and/or transport layer security (TLS).

In accordance with another aspect of the disclosure, one or more non-transitory computer-readable storage media storing computer-executable instructions that, when executed by one or more processors individually or collectively, cause a system comprising a user terminal, a service center terminal, and a server to perform operations are provided. The operations include receiving, by the user terminal, a user input requesting initialization of a password of a basic input output system (BIOS) of the user terminal, generating, by the user terminal, a ciphertext by encrypting a predetermined length of random string using a public key of the server prestored in the BIOS, in response to the user input, transmitting, by the service center terminal, the ciphertext and verification information to verify the initialization request to the server, verifying, by the server, the initialization request using the verification information, outputting, by the server, a decrypted string by decrypting the ciphertext using a prestored private key based on whether the verification is successful, and initializing, the user terminal, the password of the BIOS according to whether a second hash value for the decrypted string and a first hash value for the random string match.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating a program according to an embodiment of the disclosure;

FIG. 3 is a diagram illustrating a situation in which the initialization of a password of a basic input output system (BIOS) is performed according to an embodiment of the disclosure;

FIG. 4 is a diagram illustrating operations between a user terminal and a server to initialize a password of a BIOS according to an embodiment of the disclosure;

FIG. 5 is a block diagram of a user terminal according to an embodiment of the disclosure;

FIG. 6 is a block diagram of a server according to an embodiment of the disclosure;

FIG. 7 is a diagram illustrating operations between a user terminal, a service center terminal, and a server to initialize a password of a BIOS according to an embodiment of the disclosure;

FIG. 8 is a block diagram of a service center terminal according to an embodiment of the disclosure;

FIG. 9 is a diagram illustrating a process of initializing a password of a BIOS of a user terminal according to an embodiment of the disclosure;

FIG. 10 is a diagram illustrating a process of initializing a password of a BIOS of a user terminal according to the flow of data exchanged between devices according to an embodiment of the disclosure; and

FIG. 11 is a flowchart illustrating an operation method of a system to initialize a password of a BIOS according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

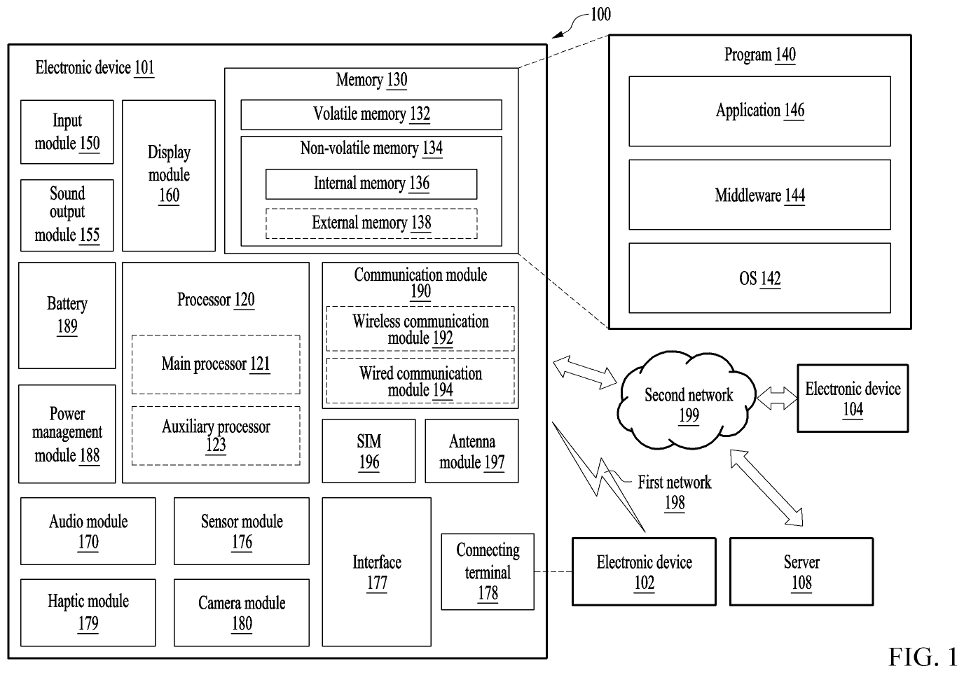

FIG. 1 is a block diagram of an electronic device in a network environment according to embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment of the disclosure, as at least a part of data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented as separate from, or as part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., a sleep) state, or together with the main processor 121 while the main processor 121 is an active state (e.g., executing an application). According to an embodiment of the disclosure, the auxiliary processor 123 (e.g., an ISP or a CP) may be implemented as a portion of another component (e.g., the camera module 180 or the communication module 190) that is functionally related to the auxiliary processor 123. According to an embodiment of the disclosure, the auxiliary processor 123 (e.g., an NPU) may include a hardware structure specified for processing of an artificial intelligence (AI) model. An artificial intelligence model may be generated by machine learning. Such learning may be performed, e.g., by the electronic device 101 where the artificial intelligence is performed, or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network, or a combination of two or more thereof, but is not limited thereto. The artificial intelligence model may, additionally or alternatively, include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing a record. The receiver may be used to receive an incoming call. According to an embodiment of the disclosure, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal or vice versa. According to an embodiment of the disclosure, the audio module 170 may obtain the sound via the input module 150, or output the sound via the sound output module 155 or an external electronic device (e.g., the external electronic device 102, such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., by wire) or wirelessly. According to an embodiment of the disclosure, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment of the disclosure, the haptic module 179 may include, for example, a motor, a piezoelectric element, or an electric stimulator.

The camera module 180 may capture a still image and moving images. According to an embodiment of the disclosure, the camera module 180 may include one or more lenses, image sensors, ISPs, or flashes.

The power management module 188 may manage power supplied to the electronic device 101. According to an embodiment of the disclosure, the power management module 188 may be implemented as, for example, at least a part of a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that operate independently of the processor 120 (e.g., an application processor) and support direct (e.g., wired) communication or wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a fourth-generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a millimeter (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), an array antenna, analog beamforming, or a large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 and 104 may be a device of a same type as, or a different type from, the electronic device 101. According to an embodiment of the disclosure, all or some of operations to be executed by the electronic device 101 may be executed at one or more external electronic devices (e.g., the external electronic devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

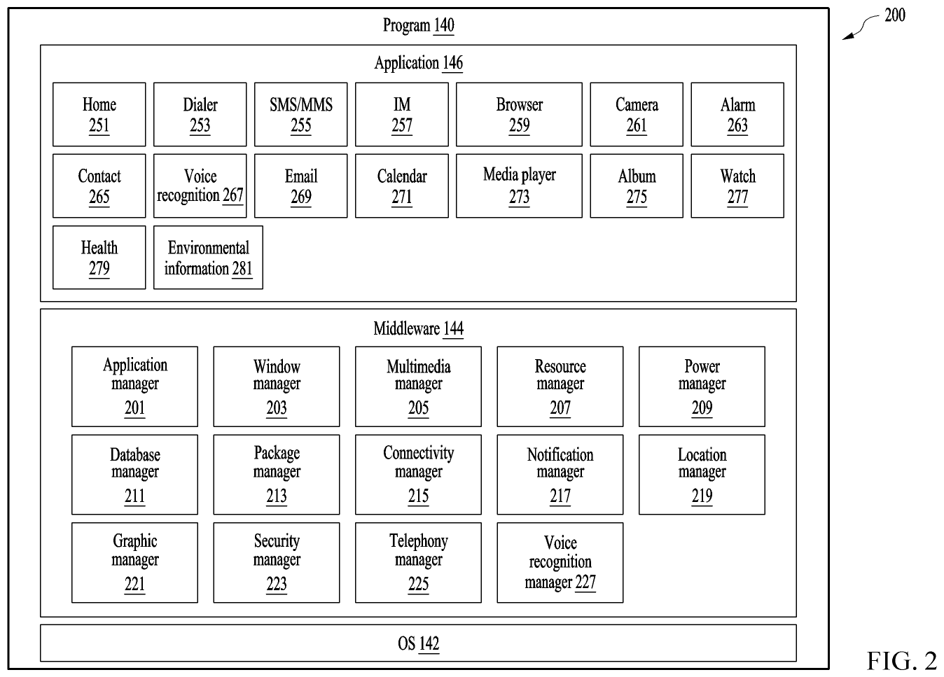

FIG. 2 is a block diagram 200 illustrating a program according to an embodiment of the disclosure.

Referring to FIG. 2, the program 140 may include an OS 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the external electronic device 102 or 104, or the server 108) during use by a user.

The OS 142 may control management (e.g., allocation or deallocation) of one or more system resources (e.g., a process, memory, or a power source) of the electronic device 101. The OS 142 may additionally or alternatively include one or more driver programs to drive other hardware devices of the electronic device 101, for example, the input module 150, the sound output module 155, the display module 160, the audio module 170, the sensor module 176, the interface 177, the haptic module 179, the camera module 180, the power management module 188, the battery 189, the communication module 190, the SIM 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database (DB) manager 211, a package manager 213, a connectivity manager 215, a notification manager 217, a location manager 219, a graphic manager 221, a security manager 223, a telephony manager 225, or a voice recognition manager 227.

The application manager 201 may, for example, manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or memory space of the memory 130. The power manager 209, for example, may manage the capacity, temperature, or power of the battery 189, and may determine or provide related information to be used for the operation of the electronic device 101 based at least in part on corresponding information of the capacity, temperature, or power of the battery 189. According to an embodiment of the disclosure, the power manager 209 may interwork with a basic input/output system (BIOS) (not shown) of the electronic device 101.

The DB manager 211, for example, may generate, search, or change a DB to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, a message, or an alert). The location manager 219, for example, may manage location information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit user's voice data to the server 108, and may receive, from the server 108, a command corresponding to a function to be executed on the electronic device 101 based on at least in part on the voice data, or text data converted based at least in part on the voice data. According to an embodiment of the disclosure, the middleware 244 may dynamically delete some existing components or add new components. According to an embodiment of the disclosure, at least part of the middleware 144 may be included as part of the OS 142 or may be implemented as another software separate from the OS 142.

The application 146 may include, for example, a home 251, a dialer 253, a short message service (SMS)/multimedia messaging service (MMS) 255, an instant message (IM) 257, a browser 259, a camera 261, an alarm 263, a contact 265, voice recognition 267, an email 269, a calendar 271, a media player 273, an album 275, a watch 277, health 279 (e.g., for measuring the degree of workout or biometric information, such as blood sugar), or environmental information 281 (e.g., for measuring air pressure, humidity, or temperature information) application. According to an embodiment of the disclosure, the application 146 may further include an information exchanging application (not shown) that is capable of supporting information exchange between the electronic device 101 and an external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of an external electronic device that communicates with the electronic device 101, or some component (e.g., a display module or a camera module of the external electronic device) of the external electronic device. The device management application may additionally or alternatively support the installation, deletion, or update of an application being operated on an external electronic device.

The electronic device according to the embodiment disclosed herein may be one of various types of electronic devices. The electronic device may include, for example, a portable communication device (e.g., a smart phone), a computer device, a portable multimedia device, a portable medical device, a camera, a wearable device, or a home appliance device. According to an embodiment of the disclosure, the electronic devices are not limited to those described above.

It should be appreciated that an embodiment of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, “A or B”, “at least one of A and B”, “at least one of A or B”, “A, B or C”, “at least one of A, B and C”, and “at least one of A, B, or C”, each of which may include any one of the items listed together in the corresponding one of the phrases, or all possible combinations thereof. Terms, such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with embodiments of the disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment of the disclosure, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101 of FIG. 1). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment of the disclosure, each component (e.g., a module or a program) of the above-described components may include a single entity or multiple entities, and some of the multiple entities may be separately disposed in different components. According to an embodiment of the disclosure, one or more of the above-described components may be omitted, or one or more other components may be added. Alternatively or additionally, a plurality of components (e.g., modules or programs) may be integrated into a single component. In such a case, according to embodiments of the disclosure, the integrated component may still perform one or more functions of each of the plurality of components in the same or similar manner as they are performed by a corresponding one of the plurality of components before the integration. According to embodiments of the disclosure, operations performed by the module, the program, or another component may be carried out sequentially, in parallel, repeatedly, or heuristically, or one or more of the operations may be executed in a different order or omitted, or one or more other operations may be added.

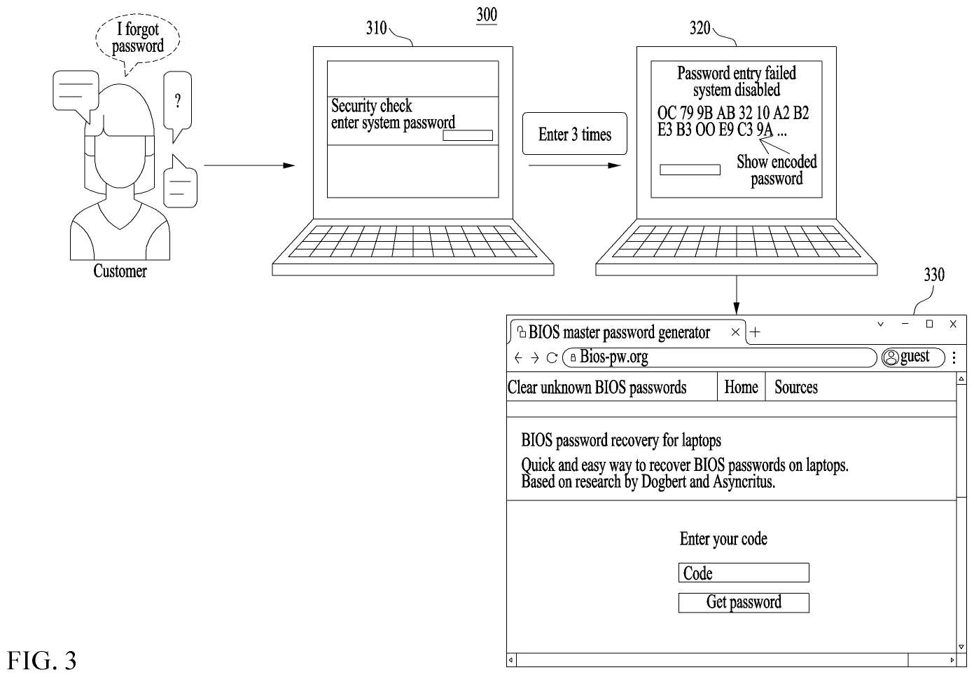

FIG. 3 is a diagram illustrating a situation in which an initialization of a password of a basic input output system (BIOS) is performed according to an embodiment of the disclosure.

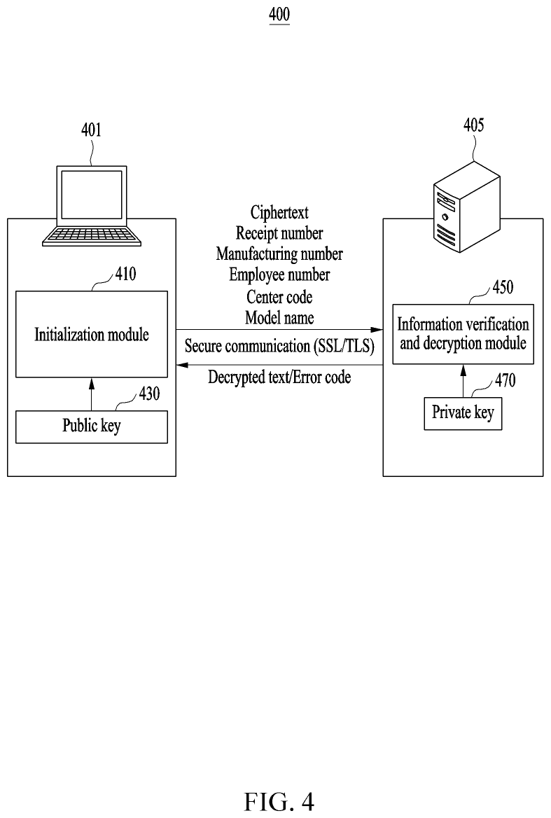

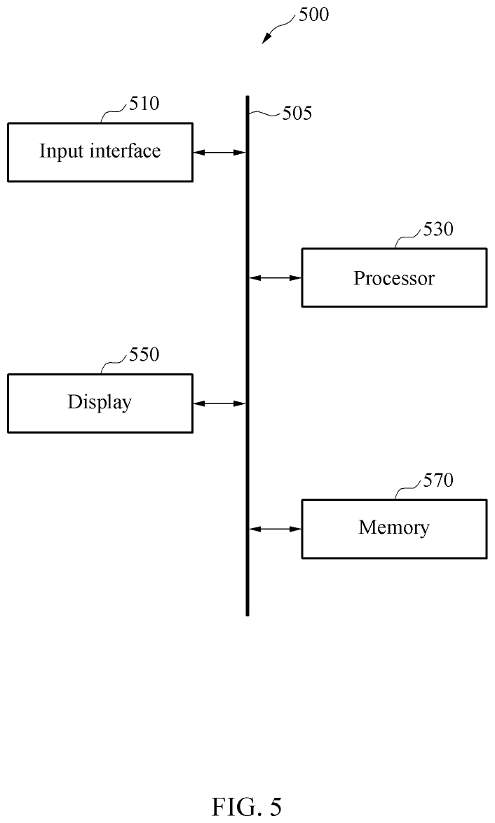

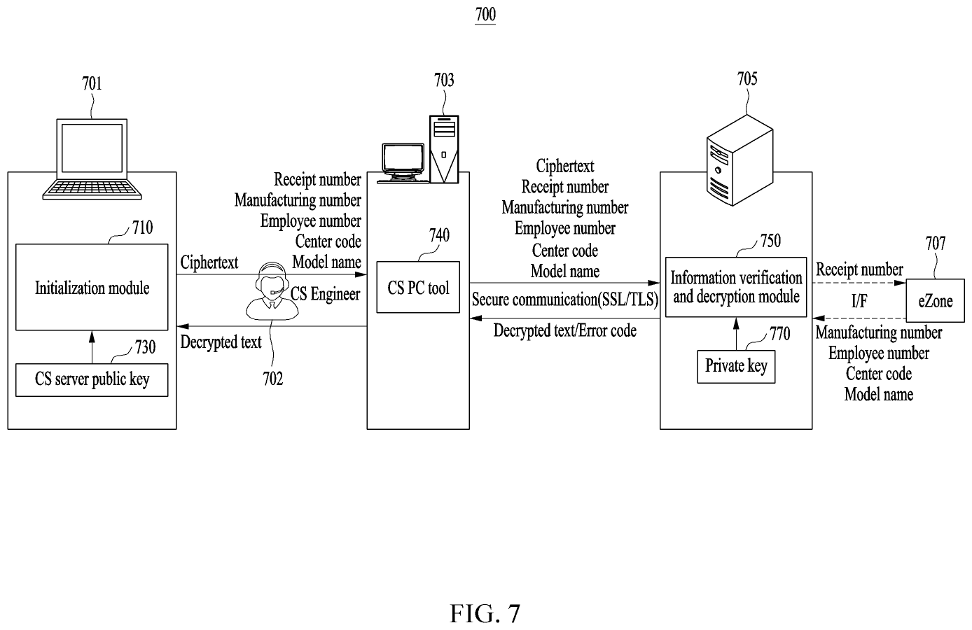

Referring to FIG. 3, a drawing 300 shows a case where a user initializes a password of a BIOS of a user terminal (e.g., the electronic device 101 of FIG. 1, a user terminal 401 of FIG. 4, a user terminal 500 of FIG. 5, and/or a user terminal 701 of FIG. 7) according to an embodiment.

When the user turns on a computer, firmware which is a program used to manage the data flow between peripheral devices and an operating system of the computer and process the input and output of the computer may be run.

For example, a BIOS, personal computer (hereinafter, “PC”) firmware present on a PC, such as a desktop and/or a laptop, may be stored, for example, in erasable programmable read-only memory (EPROM) on the mainboard, or flash memory chip. Firmware embedded in hardware other than the mainboard, such as a graphics card or interface card, is also called a BIOS in a broad sense, but in general, a BIOS may refer to one embedded in the mainboard. The BIOS runs first when a PC is turned on, checks whether the main hardware operates normally, and then starts booting by loading files of an operating system (e.g., Windows) stored in an auxiliary storage device (e.g., a hard disk or CD-ROM).

As mentioned above, PC users may protect their PCs from malicious attacks by setting up login accounts and passwords for the operating system, but such protection may be easily bypassed by changing the BIOS settings of the PCs. These bypass attacks may be prevented by allowing only authorized users to change the BIOS settings using the BIOS password. However, since it is impossible to use a PC without knowing the BIOS password, most PC manufacturers and service centers may provide password recovery or initialization services to a user who has forgotten the password.

For example, when a user who wants to initialize the BIOS password presses the Enter key three times while a BIOS password input box is empty as shown in a screen 310, a hexadecimal string may be output as shown in a screen 320. At this time, the hexadecimal string output to the screen 320 may correspond to a value obtained by encrypting a random string generated by a user PC.

The user may recover and/or initialize the BIOS password by inputting the value (e.g., code) obtained by decrypting the hexadecimal string output to the screen 320 into a code input box on a screen 330.

FIG. 4 is a diagram 400 illustrating operations between a user terminal and a server to initialize a password of a BIOS according to an embodiment of the disclosure.

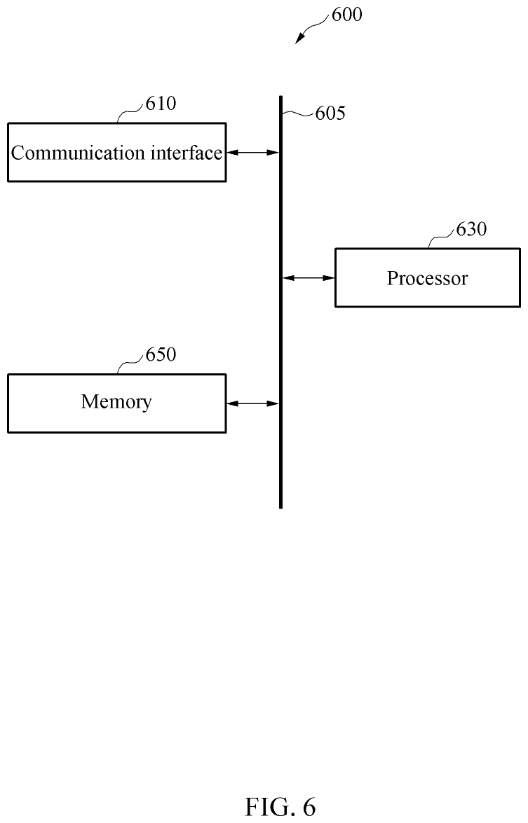

Referring to FIG. 4, a system including a user terminal 401 (e.g., the electronic device 101 of FIG. 1, the user terminal 500 of FIG. 5, and/or the user terminal 701 of FIG. 7) and a server 405 (e.g., the server 108 of FIG. 1, a server 600 of FIG. 6, and/or a server 705 of FIG. 7) according to an embodiment is shown.

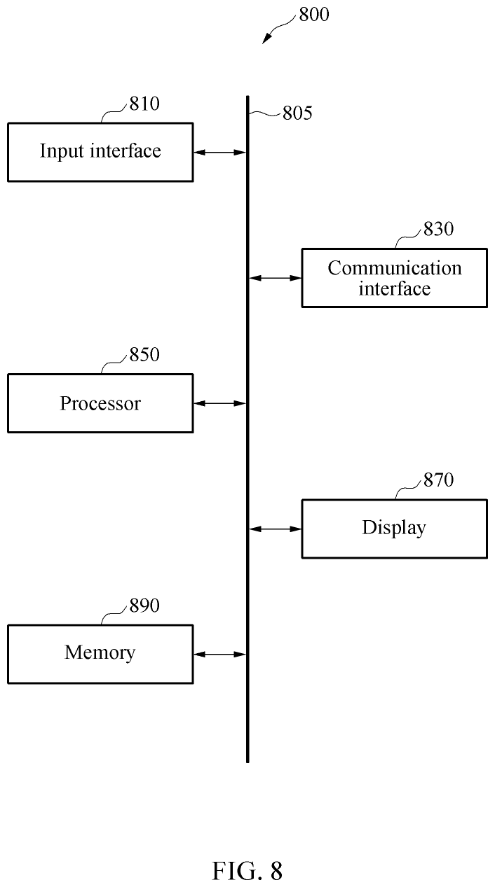

The user terminal 401 may be an electronic device for which a BIOS password is to be initialized. The user terminal 401 may include an initialization module 410 (e.g., an initialization module 710 of FIG. 7) configured to initialize the BIOS password. In addition, a public key 430 (e.g., a public key 730 of FIG. 7 and/or a public key 905 of FIG. 8) of the server 405 may be prestored in the user terminal 401. The public key 430 stored in the user terminal 401 may be one prestored, for example, during the process of producing the user terminal 401.

The server 405 may correspond to an electronic device to verify an initialization request for the BIOS password, transmitted from the user terminal 401. The server 405 may include, for example, an information verification and decryption module 450 (e.g., an information verification and decryption module 750 of FIG. 7) configured to verify verification information and decrypt a ciphertext according to the verification result. In addition, the server 405 may store a private key 470 (e.g., a private key 770 of FIG. 7 and/or a private key 915 of FIG. 8).

The public key 430 stored in the user terminal 401 and the private key 470 stored in the server 405 may be the same for all user terminals, or, for example, may be different for each manufacturing number of the user terminals 401 produced quarterly, but embodiments are not limited thereto.

In an embodiment of the disclosure, an asymmetric key encryption algorithm that uses the public key 430 stored in the user terminal 401 for encryption and the private key 470 stored in the server 405, which is different from the public key 430, for decryption may be used to verify an initialization request by the user terminal 401, thereby blocking a password initialization attempt by an unverified attacker.

For example, when a user input requesting initialization of the BIOS password of the user terminal 401 is received through the screen 310 shown in FIG. 3, the user terminal 401 may generate, encrypt, and output a predetermined length of random string through, for example, the password initialization module 410. At this time, the initialization module 410 may encrypt the random string using the public key 430 of the server 405 prestored in the user terminal 401. For example, the initialization module 410 may generate a ciphertext by encrypting a first hash value for the random string and the random string using the public key 430 of the server 405 prestored in the terminal 401.

The user terminal 401 may transmit the ciphertext obtained by encrypting the random string to the server 405. At this time, the user terminal 401 may transmit verification information to verify the initialization request for the BIOS password to the server 405 along with the ciphertext. For example, the ciphertext may be stored in the form of a file in a USB storage device and transmitted to the server 405, or may be recognized by a character recognition function of the user terminal 401 and/or a QR code scanner function of the user terminal 401 and transmitted to the server 405. Alternatively, the user terminal 401 may transmit the verification information including the ciphertext to the server 405 through a web page of the server 405 accessed by, for example, a web browser.

The verification information may include, for example, at least one of a receipt number assigned to the user terminal 401 when the user terminal 401 is sold, a center code of a service center to which a service center terminal (e.g., a service center terminal 703 of FIG. 7 and/or a service center terminal 800 of FIG. 8) belongs, an employee number of a service center employee (e.g., a service center employee 702 of FIG. 7), a manufacturing number of the user terminal 401, and a model name of the user terminal 401, and is not necessarily limited thereto.

The server 405 may verify the initialization request from the user terminal 401 by comparing the verification information transmitted by the user terminal 401 with information pre-enrolled in a database (e.g., a database 707 of FIG. 7). For example, the pre-enrolled information may be stored in the database 707 or may be stored in a cloud, and/or a separate management system. The process of the verifying the initialization request by the server 405 will be described below with reference to FIGS. 6 and 7.

Depending on the verification result, the server 405 may reply with a decrypted text (e.g., a decrypted string), obtained by decrypting the ciphertext using the prestored private key 470, and/or an error code. At this time, the prestored private key 470 is a factor that determines whether it is possible to initialize the BIOS password of the user terminal 401, and may serve to allow the initialization of the password only through the server 405.

As the verification using the verification information is successfully performed in the server 405, the user terminal 401 may receive the decrypted text (e.g., the decrypted string) obtained by the server 405 decrypting the ciphertext. The user terminal 401 may initialize the password according to the result of comparing a first hash value of the stored random string and a second hash value of the decrypted string.

If the server 405 fails verification by the verification information, the server 405 may transmit the error code to the user terminal 401. The user terminal 401 receiving the error core may not initialize the BIOS password.

The user terminal 401 and the server 405 may exchange data using a secure communication protocol to prevent the data from being modulated, thereby reducing the possibility of attacks occurring during the BIOS password initialization process. The secure communication protocol may be, for example, secure sockets layer (SSL) and/or transport layer security (TLS), but is not necessarily limited thereto.

In an embodiment of the disclosure, by verifying whether the initialization request by the user terminal 401 is a request by a legitimate user based on whether it is possible to decrypt the ciphertext transmitted from the user terminal 401 to the server 405, the possibility of the BIOS password being recovered by an attacker or another terminal that is not verified may be blocked. In addition, the user terminal 401 may recognize the ciphertext using the character recognition function of the user terminal 401 and/or a QR code scanner of the user terminal 401 and transmit the ciphertext to the server 405, thereby reducing human errors, such as typos that may occur during manual input.

The initialization process described above with reference to FIG. 4 may apply likewise, for example, to the initialization of a password with the highest priority for the operation of the user terminal 401, in addition to a process of initializing a hard disk driver (HDD) password that may be set in a similar manner to the BIOS password.

FIG. 5 is a block diagram of a user terminal according to an embodiment of the disclosure.

Referring to FIG. 5, a user terminal 500 (e.g., the electronic device 101 of FIG. 1 and/or the user terminal 401 of FIG. 4) according to an embodiment may include an input interface 510 (e.g., the input module 150 of FIG. 1), a processor 530 (e.g., the processor 120 of FIG. 1), a display 550, and memory 570 (e.g., the memory 130 of FIG. 1). The input interface 510, the processor 530, the display 550, and the memory 570 may communicate with each other through a communication bus 505.

The input interface 510 may receive a user input requesting initialization of a BIOS password of the user terminal 500.

The input interface 510 may receive a decrypted string obtained by decrypting a ciphertext for the initialization of the BIOS password, as the initialization request is verified based on verification information from the server 600. The verification information may include, for example, at least one of a receipt number assigned to the user terminal 500 when the user terminal 500 is sold, a center code of a service center to which a service center terminal (e.g., the service center terminal 703 of FIG. 7 and/or the service center terminal 800 of FIG. 8) belongs, an employee number of a service center employee, a manufacturing number of the user terminal 500, and a model name of the user terminal 500, and is not necessarily limited thereto.

For example, the ciphertext may be converted into a form that can be manually input and input into a server using a keyboard, may be converted into the form that can be manually input, recognized by a camera or character recognizer, and input into the server, or may be converted into a QR code form, recognized by a QR code scanner, and input into the server.

The input interface 510 may include, various input devices, such as a keyboard, a camera, a character recognizer, and a QR code scanner, but is not necessarily limited thereto. For example, the input interface 510 may transmit the ciphertext converted into the form that can be manually input, input by the keyboard, to the server 600, may transmit the ciphertext converted into the form that can be manually input, recognized by the camera or character recognizer, to the server 600, or may recognize the ciphertext converted into the QR code form recognized by the QR code scanner and transmit the ciphertext to the server 600.

The ciphertext and the verification information may be input into the server 600 through at least one of a tool installed on the service center terminal 703 and a web page of the server 600.

The processor 530 may generate the ciphertext by encrypting a predetermined length of random string, in response to the user input requesting the initialization of the BIOS password.

The processor 530 may generate the random string and generate a first hash value for the random string. The processor 530 may generate the ciphertext by encrypting the random string using a public key (e.g., the public key 430 of FIG. 4, the public key 730 of FIG. 7, and/or the public key 905 of FIG. 8) of the server 600 prestored in the BIOS. For example, the processor 530 may generate the ciphertext by encrypting the random string and the first hash value for the random string using the public key (e.g., the public key 430 of FIG. 4, the public key 730 of FIG. 7, and/or the public key 905 of FIG. 8) of the server 600 prestored in the BIOS.

The processor 530 may initialize the BIOS password according to whether a second hash value for the decrypted string received by the input interface 510 matches the first hash value for the random string.

For example, when the first hash value and the second hash value do not match, the processor 530 may initialize the BIOS password according to whether the second hash value received repeatedly a preset number of times through the input interface 510 matches the first hash value. The processor 530 may generate a new random string when the second hash value received repeatedly does not match the first hash value. The processor 530 may reset the user terminal 500 and generate the new random string. At this time, the reason for re-generating a new random string while limiting the number of times to receive the second hash value is to reduce brute force attacks and reduce the possibility of a string verification logic being exposed through memory dump. Here, a brute force attack may correspond to a brute force technique for initializing a password through a brute-force operation of all random strings to be generated by the user terminal to the user terminal 500. Further, the memory dump may correspond to a technique for outputting a record of the state of working memory 570 of a computer program at a predetermined timepoint.

Further, the processor 530 may convert the ciphertext into a form that can be manually input or a QR code form and output the ciphertext through the display 550.

In addition, the processor 530 may perform the at least one method associated with the user terminal 500 described above with reference to FIGS. 4 to 11 or a technique corresponding to the at least one method. The processor 530 may be a hardware-implemented electronic device having a physically structured circuit to execute desired operations. The desired operations may include, for example, code or instructions included in a program. The hardware-implemented user terminal 500 may include, for example, a microprocessor, a CPU, a GPU, a processor core, a multi-core processor, a multiprocessor, an ASIC, a field-programmable gate array (FPGA), and/or an NPU.

The display 550 may output the ciphertext converted by the processor 530 into the form that can be manually input and/or the QR code form to a screen.

The memory 570 may store at least one program. Further, the memory 570 may store a variety of information generated during the processing process of the processor 530. In addition, the memory 570 may store a variety of data and programs. The memory 570 may include, for example, volatile memory (e.g., the volatile memory 132 of FIG. 1) or non-volatile memory (e.g., the non-volatile memory 134 of FIG. 1). The memory 570 may include a high-capacity storage medium, such as a hard disk to store a variety of data.

FIG. 6 is a block diagram of a server according to an embodiment of the disclosure.

Referring to FIG. 6, a server 600 according to an embodiment may include a communication interface 610, a processor 630, and memory 650. The communication interface 610, the processor 630, and the memory 650 may be connected to each other through a communication bus 605.

The communication interface 610 may receive a ciphertext for the initialization of a BIOS password of a user terminal (e.g., the electronic device 101 of FIG. 1, the user terminal 401 of FIG. 4, the user terminal 500 of FIG. 5, and/or the user terminal 701 of FIG. 7) and verification information to verify the initialization request.

Further, the communication interface 610 may output a decrypted string generated by the processor 630.

The processor 630 may verify the initialization request by comparing the verification information received by the communication interface 610 with pre-enrolled information. The processor 630 may request a database (e.g., the database 707 of FIG. 7) storing and managing pre-enrolled information corresponding to the user terminal 500 to search for a receipt number included in the verification information. The processor 630 may request the database 707 to search for the receipt number in a uniform resource locator (URL) form, for example. At this time, the communication interface 610 may receive found pre-enrolled information corresponding to the receipt number from the database 707.

The processor 630 may output an error code through the communication interface 610 when the result of searching for the receipt number shows that the receipt number is not found in the database 707, when the result of searching for the receipt number shows that the pre-enrolled information corresponding to the receipt number is not found in the database 707, or when the verification fails according to a comparison result showing that the verification information and the pre-enrolled information do not match.

The processor 630 may generate a decrypted string by decrypting the ciphertext using a prestored private key (e.g., the private key 470 of FIG. 4, the private key 770 of FIG. 7, and/or the private key 915 of FIG. 8) based on the verification result.

In addition, the processor 630 may perform the at least one method associated with the server 600 described with reference to FIGS. 4 to 11 or a technique corresponding to the at least one method. The processor 630 may be a hardware-implemented electronic device having a physically structured circuit to execute desired operations. The desired operations may include, for example, code or instructions included in a program. The hardware-implemented server 600 may include, for example, a microprocessor, a CPU, a GPU, a processor core, a multi-core processor, a multiprocessor, an ASIC, an FPGA, and/or an NPU.

The memory 650 may store at least one program. Further, the memory 650 may store a variety of information generated during the processing process of the processor 630. In addition, the memory 650 may store a variety of data and programs. The memory 650 may include, for example, volatile memory (e.g., the volatile memory 132 of FIG. 1) or non-volatile memory (e.g., the non-volatile memory 134 of FIG. 1). The memory 650 may include a high-capacity storage medium, such as a hard disk to store a variety of data.

FIG. 7 is a diagram 700 illustrating operations between a user terminal, a service center terminal, and a server to initialize a password of a BIOS according to an embodiment of the disclosure.

Referring to FIG. 7, a system including the user terminal 701 (e.g., the electronic device 101 of FIG. 1, the user terminal 401 of FIG. 4, and/or the user terminal 500 of FIG. 5), the service center terminal 703 (e.g., the service center terminal 800 of FIG. 8), the server 705 (e.g., the server 108 of FIG. 1, the server 405 of FIG. 4, and/or the server 600 of FIG. 6), and the database 707 according to an embodiment is shown. In the embodiment of FIG. 7, for ease of description, the database 707 and the server 705 are shown as separate and distinct objects, but embodiments are not necessarily limited thereto. For example, the database 707 may be included in the server 705, or may be included in a separate management server or cloud that is distinct from the server 705. Information generated when a product including the user terminal 701 is sold may be pre-enrolled in the database 707. The information pre-enrolled in the database 707 may include, for example, the receipt number for the corresponding sales case, the manufacturing number of the user terminal 701, the employee number of the employee 702, the center code of a service center, and the model name of the user terminal 701, but is not necessarily limited thereto.

The user terminal 701 may correspond to a terminal for which a BIOS password is to be initialized. The user terminal 701 may include an initialization module 710 configured to initialize the BIOS password. Further, the public key 730 (e.g., the public key 430 of FIG. 4 and/or the public key 905 of FIG. 8) of the server 705 may be prestored in the user terminal 701. For example, the public key 730 stored in the user terminal 701 may be one stored during the process of producing the user terminal 701.

The service center terminal 703 may correspond to a terminal installed in a service center that is requested to initialize the BIOS password by a user of the user terminal 701. The service center terminal 703 may serve to transmit the ciphertext and/or verification information output to a screen of the user terminal 701 to the server 705. Depending on the embodiment of the disclosure, the service center terminal 703 may transmit the ciphertext obtained from the user terminal 701 to the server 705 along with the verification information identified by the service center terminal 703.

Further, the server 705 may correspond to a device to verify an initialization request for the BIOS password, transmitted from the user terminal 701. The server 705 may include, for example, the information verification and decryption module 750 configured to verify verification information and decrypt a ciphertext. Further, the server 705 may include the private key 770.

In an embodiment of the disclosure, an asymmetric key encryption algorithm that uses the public key 730 stored in the user terminal 701 for encryption and the private key 770 stored in the server 705, which is different from the public key 730, for decryption may be used to verify an initialization request by the user terminal 701, thereby blocking password initialization by an attacker.

For example, when a user input requesting initialization of the BIOS password of the user terminal 701 is received through the screen shown in FIG. 7, the user terminal 701 may generate, encrypt, and output a predetermined length of random string to the screen through, for example, the password initialization module 710. At this time, the initialization module 710 may encrypt the random string using the public key 730 of the server 705 prestored in the user terminal 701.

The service center employee 702 (e.g., engineer) may transmit the ciphertext output to the screen of the user terminal 701 to the server 705 through the service center terminal 703. At this time, the service center employee 702 may transmit verification information to verify the initialization request for the BIOS password to the server 705 through the service center terminal 703 along with the ciphertext. At this time, a tool 740 may be installed on the service center terminal 703. The service center employee 702 may input, through the tool 740, verification information, such as a receipt number assigned to the user terminal 701 when the user terminal 701 is sold, a center code of a service center to which the service center terminal 703 belongs, an employee number of the service center employee 702, a manufacturing number of the user terminal 701, and a model name of the user terminal 701, along with the ciphertext output to the user PC. At this time, the ciphertext may be input using, for example, a USB storage device, a character recognizer, a QR code, and a scanner.

The tool 740 may transmit the information input by the employee 702 to the server 705, receive a response (e.g., a decryption text or error code) thereto from the server 705, and output the response to the screen of the service center terminal 703.

Depending on the embodiment of the disclosure, the service center employee 702 may input the ciphertext and verification information through a web page of the server 705 accessed through a web browser instead of the tool 740. For example, the ciphertext may be stored in the form of a file in a USB storage device, recognized by a character recognition function of the user terminal 701 or the QR code scanner of the user terminal 701, and transmitted to the server 705. The information input into the web page of the server 705 and the operation method after the input may be the same as those when the tool 740 is used.

At this time, the service center terminal 703 and the server 705 may exchange data using a secure communication protocol to prevent the exchanged data from being modulated, thereby reducing the possibility of attacks by attackers occurring during the BIOS password initialization process. The secure communication protocol may be, for example, SSL and/or TLS, but is not necessarily limited thereto.

The server 705 may transmit the verification information (e.g., the receipt number) received from the service center terminal 703 to the database 707, and receive the manufacturing number, employee number, center code, and model name enrolled in the database 707 in relation to the receipt number.

The server 705 may verify the BIOS password initialization request based on whether the received information and the verification information match. The server 705 may decrypt the ciphertext according to the verification result and reply to the service center terminal 703. Depending on the verification result, the server 705 may reply with a decrypted string, which is a decrypted text obtained by decrypting the ciphertext using the prestored private key, and/or an error code. At this time, the prestored private key is a factor that determines whether it is possible to initialize the BIOS password of the user terminal 701, and may serve to allow the initialization of the password only through the server 705. The information verification and decryption process of the server 705 described above may be performed by the information verification and decryption module 750.

As the verification using the verification information is successfully performed in the server 705, the service center terminal 703 may receive, as a decrypted text, a decrypted string obtained by the server 705 decrypting the ciphertext. The user terminal 701 may initialize the password according to the result of comparing the random string with the decrypted string.

If the server 705 fails verification by the verification information, the server 705 may transmit an error code to the service center terminal 703. The service center employee 702 confirming the error code may not initialize the password.

FIG. 8 is a block diagram of a service center terminal according to an embodiment of the disclosure.

Referring to FIG. 8, the service center terminal 800 (e.g., the service center terminal 703 of FIG. 7) according to an embodiment may include an input interface 810, a communication interface 830, a processor 850, a display 870, and memory 890. The input interface 810, the communication interface 830, the processor 850, the display 870, and the memory 890 may be connected to each other through a communication bus 805.

The input interface 810 may receive a ciphertext and/or verification information output to a screen of a user terminal (e.g., the electronic device 101 of FIG. 1, the user terminal 401 of FIG. 4, the user terminal 500 of FIG. 5, and/or the user terminal 701 of FIG. 7) from a service center employee (e.g., the service center employee 702 of FIG. 7).

Alternatively, the communication interface 830 may receive the ciphertext for the initialization of the BIOS password output from the user terminal 701 and/or the verification information to verify an initialization request. The communication interface 830 may transmit the ciphertext and/or the verification information to verify the initialization request to a server (e.g., the server 108 of FIG. 1, the server 405 of FIG. 4, the server 600 of FIG. 6, and/or the server 705 of FIG. 7).

In addition, the communication interface 830 may receive a decrypted string, which is a decrypted text obtained by decrypting the ciphertext, and/or an error code from the server 705 according to a verification result from the server 705. For example, if the verification using the verification information is successfully performed in the server 705, the communication interface 830 may receive the decrypted text from the server 705. In contrast, when the server 705 fails verification using the verification information, the communication interface 830 may receive the error code from the server 705.

The communication interface 830 may transmit and receive information to and from the user terminal 701 using a secure communication protocol. In addition, the communication interface 830 may transmit and receive information to and from the server 705 using the secure communication protocol.

The processor 850 may execute instructions programmed in a tool (e.g., the tool 740 of FIG. 7) stored in the memory 890. The tool 740 may correspond to a software program written to transmit, through the communication interface 830 to the server 705, information received through the input interface 810, such as, for example, a keyboard, from the service center employee (e.g., the service center employee 702 of FIG. 7), receive a response (e.g., a decrypted text or error code) thereto from the server 705, and output the response to the display 870 of the service center terminal 800.

In addition, the processor 850 may perform the at least one method associated with the service center terminal 800 described with reference to FIGS. 4 to 11 or a technique corresponding to the at least one method. The processor 850 may be a hardware-implemented electronic device having a physically structured circuit to execute desired operations. The desired operations may include, for example, code or instructions included in a program. The hardware-implemented service center terminal 800 may include, for example, a microprocessor, a CPU, a GPU, a processor core, a multi-core processor, a multiprocessor, an ASIC, an FPGA, and/or an NPU.

The display 870 may display the decrypted text or error code transmitted from the server 705 through the communication interface 830. The service center employee 702 may manually input the decrypted string output to the display 870 of the service center terminal 800 into an input box of the user terminal 701.

The memory 890 may store at least one program including, for example, the tool 740. Further, the memory 890 may store a variety of information generated during the processing process of the processor 850. In addition, the memory 890 may store a variety of data and programs. The memory 890 may include, for example, volatile memory (e.g., the volatile memory 132 of FIG. 1) or non-volatile memory (e.g., the non-volatile memory 134 of FIG. 1). The memory 890 may include a high-capacity storage medium, such as a hard disk to store a variety of data.

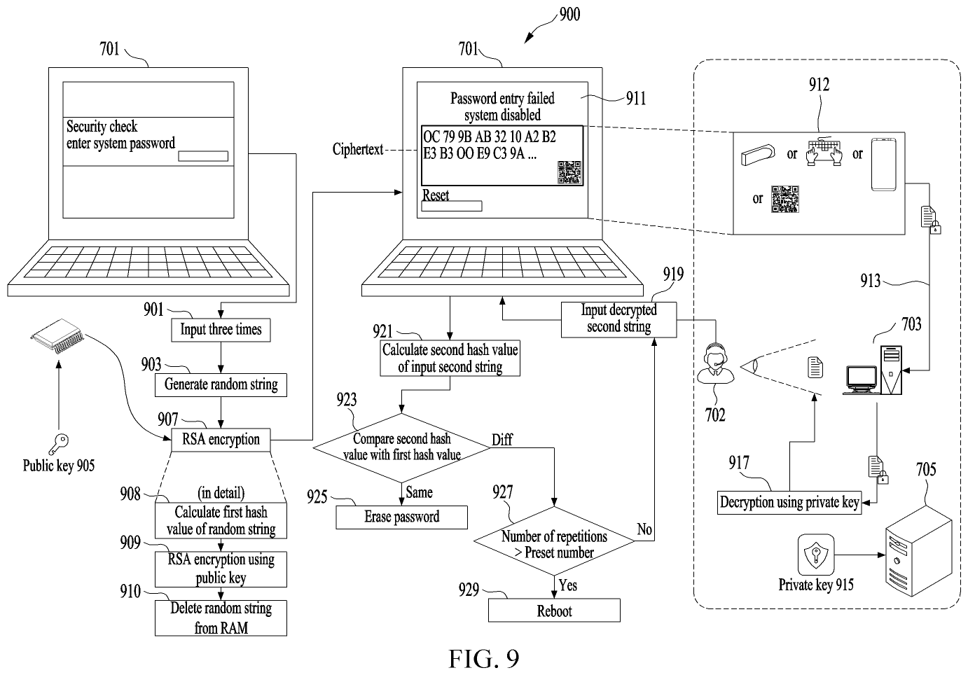

FIG. 9 is a diagram 900 illustrating a process of initializing a password of a BIOS of a user terminal according to an embodiment of the disclosure.

Referring to FIG. 9, the user terminal 701 (e.g., the electronic device 101 of FIG. 1, the user terminal 401 of FIG. 4, and/or the user terminal 500 of FIG. 5), the service center terminal 703 (e.g., the service center terminal 800), and the server 705 (e.g., the server 108 of FIG. 1, the server 405 of FIG. 4, and/or the server 600 of FIG. 6) according to an embodiment may initialize the BIOS password of the user terminal 701 through operations 901 to 929.

In operation 901, a user may press the Enter key three times on the screen 310 shown in FIG. 3, for example, as described above while a BIOS password input box of the user terminal 701 is empty.

In this case, in operation 903, the user terminal 701 may generate a random string corresponding to a predetermined length of (e.g., hexadecimal) string. The random string may correspond to a value obtained by encoding the BIOS password set by the user. The random string may be stored, for example, in memory (e.g., the memory 130 of FIG. 1 and/or the memory 570 of FIG. 5) of the user terminal 701. The memory 570 may be, for example, random-access memory (RAM).

In operation 907, the user terminal 701 may perform encryption on the random string. For example, the user terminal 701 may perform encryption on the random string using an asymmetric encryption technique, such as, for example, Rivest-Shamir-Adleman (RSA) encryption, but embodiments are not necessarily limited thereto. The RSA encryption may be an encryption method that uses the public key 905 (e.g., the public key 430 of FIG. 4 and/or the public key 730 of FIG. 7) that is public to everyone and the public key 915 (e.g., the private key 470 of FIG. 4 and/or the private key 770 of FIG. 7) that is not public to others and kept private. The private key may also be called a “secret key” and may be used to decrypt a message encrypted by the public key 905.

More specifically, the user terminal 701 may perform encryption on the random string through operations 908 to 910 below.

In operation 908, the user terminal 701 may calculate a first hash value for the random string and store the first hash value in the memory (e.g., the memory 130 of FIG. 1 and/or the memory 570).

In operation 909, the user terminal 701 may perform RSA encryption on the random string using the prestored public key 905 of the server 705. The user terminal 701 may encrypt the random string using, for example, an RSA-2048 public key 905, but embodiments are not necessarily limited thereto. At this time, the public key 905 of the server 705 may be prestored in the BIOS of the user terminal 701, for example, in a hard coding form.

As the encryption of the random string is completed, in operation 910, the user terminal 701 may delete the random string generated in operation 903 and stored in the memory 570. The user terminal 701 may delete the random string from the memory 570 at this time to reduce the possibility of an attacker obtaining the random string using an abnormal method through a vulnerability or attacks, not through a normal protocol.

In operation 911, the user terminal 701 may store a ciphertext obtained by encrypting the random string as a file, or convert the ciphertext into a form that can be manually input or a QR code form and output the ciphertext to a screen (e.g., the screen 320 of FIG. 3) of the user terminal 701. The user terminal 701 may convert the ciphertext into a form that can be manually input, for example, using a hexadecimal string (hex string) method, a Base32 encoding method, and/or a Base64 encoding method. The hexadecimal string method may express data to be transmitted as a hexadecimal string. The Base32 encoding method may express data to be transmitted using a 32-character set of 26 uppercase letters (A-Z) and 6 numbers (2-7). Further, the Base64 encoding may express 8-bit binary data into only characters in the common ASCII area that are not affected by character codes.

In operation 912, the service center employee 702 may input the ciphertext into a tool installed on the service center terminal 703 and/or a web page of the server 705. Alternatively, the service center employee 702 may capture the ciphertext in a form that can be input, output to the screen of the user terminal 701, using a camera connected to the service center terminal 703, recognize the ciphertext using a character recognition function of a mobile device, or input the ciphertext into the tool installed on the service center terminal 703 and/or the web page of the server 705 directly using a keyboard. The service center employee 702 may input, into the tool or web page, verification information including, for example, a receipt number, a manufacturing number, an employee number, a center code, and a model name along with the ciphertext. In addition, the service center employee 702 may input the ciphertext by recognizing the QR code output to the user terminal 701 using the camera or QR code scanner connected to the service center terminal 703.

Alternatively, in operation 913, the service center employee 702 may transmit the ciphertext to the server 705 by copying a ciphertext file stored in the user terminal 701 to a USB storage device and then connecting the USB storage device to the service center terminal 703. The service center terminal 703 or the web page may transmit the input ciphertext and verification information to the server 705. The server 705 may transmit the receipt number included in the verification information in a URL form to a database (e.g., the database 707 of FIG. 7) or a management system.

The database 707 or the management system may search with the receipt number received from the server 705, determine whether the receipt number is previously enrolled, and then reply to the server 705 with a manufacturing number, an employee number, a center code, and a model name corresponding to the receipt number. If the receipt number received from the server 705 has not been previously enrolled, the database 707 may return a FAIL signal to the server 705.

The server 705 may compare the information received from the database 707 and the information received from the user terminal 701. The server 705 may compare the manufacturing number, employee number, center code, and model name received from the database 707 with the manufacturing number, employee number, center code, and model name received from the user terminal 701, respectively.

If the comparison result shows that all items of the information match, in operation 917, the server 705 may reply to the service center terminal 703 with a decrypted string obtained by decrypting the received ciphertext using the prestored private key 915. The private key 915 may be, for example, an RSA-2048 private key, but is not necessarily limited thereto.

When the comparison result shows that any one item of the information does not match or when a FAIL signal is returned from the database 707, the server 705 may reply to the service center terminal 703 with an error code.

The service center terminal 703 may output the decrypted string received from the server 705 to the screen.

Meanwhile, the data exchanged between the service center terminal 703 and the server 705 may be protected through the SSL/TLS protocol not to be forged and/or modulated.

In operation 919, the service center employee 702 may manually input the decrypted string output to the screen of the service center terminal 703 into the input box of the user terminal 701. If normal, the decrypted string may be the value of a random string of a predetermined length (e.g., 16 bytes) generated by the user terminal 701, the length of which may be much smaller than the length of most electronic signatures. In an embodiment of the disclosure, by adjusting the length of the random string, the length of the value to be manually input into the user terminal 701 in operation 919 may be reduced.

In operation 921, the user terminal 701 may calculate a second hash value for the decrypted string input in operation 919.

In operation 923, the user terminal 701 may compare the first hash value for the random string stored in the memory 570 with the second hash value calculated in operation 921.

When a result of the comparison in operation 923 shows that the first hash value and the second hash value match (Same), in operation 925, the user terminal 701 may consider that authentication is normally performed by the server 705 and initialize the password by itself. As the password is initialized, the user terminal 701 may erase the previously set password.

When the result of the comparison in operation 923 shows that the first hash value and the second hash value do not match (Diff), in operation 927, the user terminal 701 may request the user to repeatedly re-enter the decrypted string a preset number of times. Re-inputting the decrypted string may be performed a number of times (e.g., 3 times) limited by the policy. At this time, the reasons for limiting the number of re-inputs of the decrypted string are to reduce attacks by the brute force technique as described above and to reduce the possibility of string verification logic being exposed through memory dump.

If the second hash value repeatedly input the preset number of times in operation 927 does not match the first hash value, the user terminal 701 may be reset and rebooted, in operation 929. Accordingly, the user terminal 701 may generate a new random string.

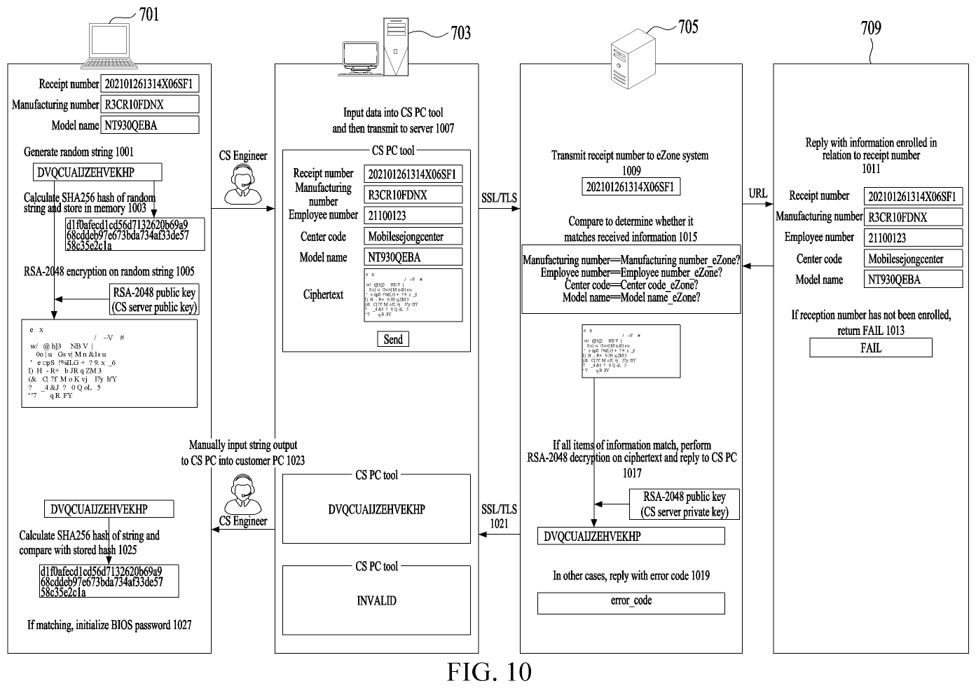

FIG. 10 is a diagram illustrating a process of initializing a password of a BIOS of a user terminal according to the flow of data exchanged between devices according to an embodiment of the disclosure.

Referring to FIG. 10, the processes of initializing a BIOS password using, for example, an RSA-2048 public key algorithm, by the user terminal 701 (e.g., the electronic device 101 of FIG. 1, the user terminal 401 of FIG. 4, and/or the user terminal 500 of FIG. 5), the service center terminal 703 (e.g., the service center terminal 800 of FIG. 8), the server 705 (e.g., the server 108 of FIG. 1, the server 405 of FIG. 4, and/or the server 600 of FIG. 6), and the database 707 according to an embodiment are shown.

When the user terminal 701 receives a user input requesting the initialization of the BIOS password, including verification information, the user terminal 701 may generate a 16-byte random string (e.g., “DVQCUAIJZEHVEKHP”), in operation 1001. At this time, the initialization request for the BIOS password may be input along with, for example, the receipt number (e.g., “20210126134X06SAF1”) assigned to the user terminal 701 when the user terminal 701 is sold, the manufacturing number (e.g., “R3CR10FDNX”) of the user terminal 701, and the model name (e.g., “NT93QEBA”) of the user terminal 701.

In operation 1003, the user terminal 701 may calculate a hash value (“first hash value”) (e.g., “d1f0afecd1cd56d7a32620b69a968cddeb97e673bda734af33de5758c35e2c1a”) of a random string using, for example, the SHA256 hash function, and store the first hash value in memory (e.g., the memory 130 of FIG. 1 and/or the memory 570).

In operation 1005, the user terminal 701 may encrypt the random string generated in operation 1001 using the RSA-2048 public key algorithm. The random string may be encrypted using an RSA-2048 public key (e.g., the public key 430 of FIG. 4, the public key 730 of FIG. 7, and/or the public key 905 of FIG. 8) prestored in the user terminal 701. When a ciphertext is generated, the user terminal 701 may delete the value of the random string stored in the memory 570. In operation 1005, the user terminal 701 may convert the generated ciphertext into a form that can be manually input and/or a QR code form and output the ciphertext to the screen.

In operation 1007, the service center employee 702 may transmit the ciphertext output to the screen in operation 1005 to the server 705 by inputting, into a tool of the service center terminal 703 or a web page of the server 705, the ciphertext along with verification information, such as, for example, the receipt number (e.g., “20210126134X06SAF1”) assigned to the user terminal 701, the manufacturing number (e.g., “R3CR10FDNX”) of the user terminal 701, the employee number (e.g., “21100123”) of the service center employee, the center code (e.g., “Mobilesejongcenter”) of the service center to which the service center terminal 703 belongs, and the model name (e.g., “NT93QEBA”) of the user terminal 701.

In an embodiment of the disclosure, in addition to the verification information (e.g., the receipt number, manufacturing number, and/or model name) transmitted by the user terminal 701, the verification information to verify the service center (e.g., the employee number, and/or the sensor code) may be added to maintain a higher level of verification and/or security for the initialization request transmitted through the service center to the server.

When the ciphertext and the verification information are transmitted to the server 705 through operation 1007, the server 705 may transmit the receipt number included in the verification information to a database (e.g., the database 707 of FIG. 7) or a management system (e.g., eZone system) 709, in operation 1009.

In operation 1011, the database 707 or the management system 709 may search with the receipt number to search for the enrolled manufacturing number, employee number, center code, and model name corresponding to the receipt number and reply to the server 705 with the same.

For example, if the receipt number transmitted in operation 1007 has not been enrolled in the database 707 or the management system 709, the database 707 or the management system 709 may return a FAIL signal to the server 705, in operation 1013.

In operation 1015, the server 705 may compare the manufacturing numbers, employee numbers, center codes, and model names, respectively, to determine whether the information received in operation 1011 matches the information received through the service center terminal 703.

When a result of the comparison in operation 1015 shows all items of the information match, the server 705 may generate a decrypted string (e.g., “DVQCUAIJZEHVEKHP”) by decrypting the ciphertext received from the service center terminal 703 using an RSA-2048 private key (e.g., the private key 470 of FIG. 4, the private key 770 of FIG. 7, and/or the private key 915 of FIG. 8) in operation 1017, and transmit the decrypted string to the service center terminal 703 in operation 1021. At this time, the RSA-2048 private key 915 may be one prestored in the server 705. In an embodiment of the disclosure, the data exchanged between the server 705 and the service center terminal 703 may be transmitted using a secure communication protocol, such as, for example, SSL and/or TLS, to reduce the possibility of attacks occurring during the BIOS password initialization process.

When the result of the comparison in operation 1015 shows that any one item of the information does not match or when a FAIL signal is returned to the server 705 from the database 707 or the management system 709, the server 705 may reply to the service center terminal 703 with an error code, in operation 1019.

When the decrypted string (e.g., “DVQCUAIJZEHVEKHP”) transmitted through operation 1021 is output to the screen of the service center terminal 703, the service center employee 702 may input the decrypted string (e.g., “DVQCUAIJZEHVEKHP”) output to the screen into the user terminal 701, in operation 1023.

In operation 1025, the user terminal 701 may calculate a second hash value for the decrypted string input by the service center employee 702 using, for example, the SHA256 hash function, and compare the second hash value with the first hash value stored in the memory 570 of the user terminal 701.

When a result of the comparison in operation 1025 shows that the first hash value and the second hash value match, the user terminal 701 may initialize the BIOS password, in operation 1027.

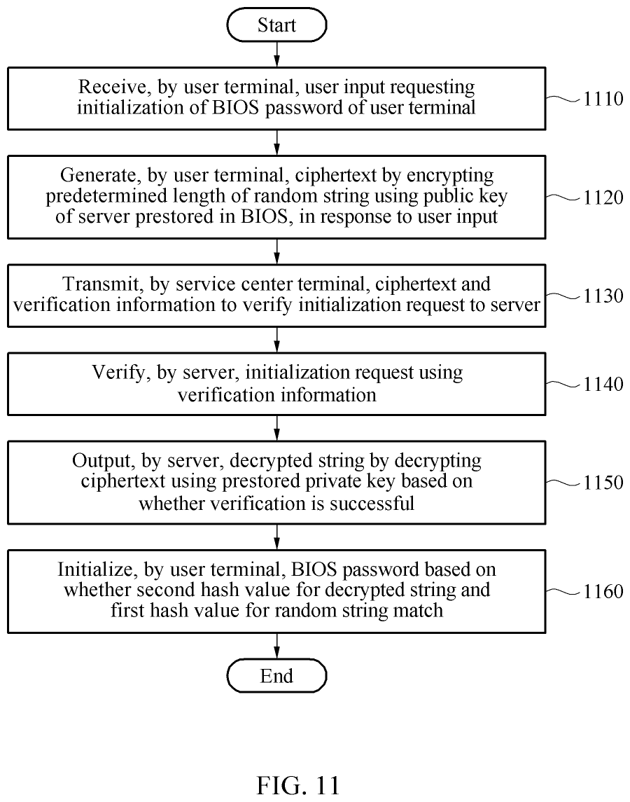

FIG. 11 is a flowchart illustrating an operation method of a system to initialize a password of a BIOS according to an embodiment of the disclosure.

In the following embodiment of the disclosure, operations may be performed sequentially, but are not necessarily performed sequentially. For example, the operations may be performed in different orders, and at least two of the operations may be performed in parallel.

Referring to FIG. 11, a system including a user terminal (e.g., the electronic device 101 of FIG. 1, the user terminal 401 of FIG. 4, the user terminal 500 of FIG. 5, and/or the user terminal of FIG. 7) according to an embodiment. 701) and a server (e.g., the server 108 of FIG. 1, the server 405 of FIG. 4, the server 600 of FIG. 6, and/or the server 705 of FIG. 7) may initialize a BIOS password of the user terminal 701 through operations 1110 to 1160.

In operation 1110, the user terminal 701 may receive a user input requesting the initialization of the BIOS password of the user terminal 701.

In operation 1120, the user terminal 701 may generate a ciphertext by encrypting a predetermined length of random string using a public key (e.g., the public key 430 of FIG. 4, the public key 730 of FIG. 7, and/or the public key 905 of FIG. 8) of the server 705 prestored in the BIOS, in response to the user input received in operation 1110.

In operation 1130, the user terminal 701 may transmit verification information to verify the ciphertext generated in operation 1120 and the initialization request to the server 705. In operation 1130, the user terminal 701 may convert the ciphertext into a form that can be manually input or a QR code form and output the ciphertext to a screen of the user terminal 701. In this case, the user terminal 701 may transmit the ciphertext stored in the form of a file in the user terminal 701 to the server 705, transmit the ciphertext converted into the form that can be manually input into the server 705 through a keyboard input, recognize the ciphertext converted into the form that can be manually input using a camera or character recognizer and transmit the ciphertext to the server 705, or recognize the ciphertext converted into the QR code form using a QR code scanner and transmit the ciphertext to the server 705.

Depending on the embodiment of the disclosure, for example, the user terminal 701 may transmit the ciphertext and verification information to the server 705 through at least one of a tool installed on a service center terminal (e.g., the service center terminal 703 of FIG. 7 and/or the service center terminal 800 of FIG. 8) and a web page of the server 705.

In operation 1140, the server 705 may verify the initialization request using the verification information received in operation 1130. The verification information may include, for example, at least one of a receipt number assigned to the user terminal 701 when the user terminal 701 is sold, a center code of a service center to which the service center terminal 703 belongs, an employee number of a service center employee, a manufacturing number of the user terminal 701, and a model name of the user terminal 701, and is not necessarily limited thereto.

In operation 1150, the server 705 may output a decrypted string by decrypting the ciphertext using a prestored private key (e.g., the private key 470 of FIG. 4, the private key 770 of FIG. 7, and/or the private key 915 of FIG. 8) prestored by the server 705, based on whether the verification is successful in operation 1140.

In operation 1160, the user terminal 701 may initialize the BIOS password depending on whether a second hash value for the decrypted string output in operation 1150 matches the first hash value. The user terminal 701 may determine whether the first hash value and the second hash value match. If the first hash value and the second hash value do not match, the user terminal 701 may repeatedly receive the second hash value a preset number of times. The user terminal 701 may initialize the BIOS password depending on whether the repeatedly received second hash value matches the first hash value. For example, when the repeatedly received second hash value does not match the first hash value, the user terminal 701 may reset the user terminal 701 and generate a new random string.

According to an embodiment of the disclosure, the electronic device 101, the user terminal 401, 500, 701 may include an input interface 510 configured to receive a user input requesting initialization of a password of a BIOS of the electronic device 101, the user terminal 401, 500, 701, and receive a decrypted string obtained by decrypting a ciphertext for the initialization in response to the initialization request being verified based on verification information from a server 108, 405, 600, 705, and a processor 120, 630 configured to generate the ciphertext by encrypting a predetermined length of random string, in response to the user input, and initialize the password of the BIOS according to whether a second hash value for the decrypted string and a first hash value for the random string match.

According to an embodiment of the disclosure, the processor 120, 630 may generate the random string, generate the first hash value for the random string, and generate the ciphertext using a public key 430, 730, 905 of the server 108, 405, 600, 705 prestored in the BIOS.

According to an embodiment of the disclosure, when the first hash value and the second hash value do not match, the processor 120, 630 may initialize the password of the BIOS according to whether the second hash value received repeatedly a preset number of times through the input interface 510 matches the first hash value.

According to an embodiment of the disclosure, the processor 120, 630 may generate a new random string when the second hash value received repeatedly does not match the first hash value.

According to an embodiment of the disclosure, the processor 120, 630 may convert the ciphertext into a form that can be manually input or a QR code form and output the ciphertext to a screen of the electronic device 101, the user terminal 401, 500, 701.

According to an embodiment of the disclosure, the ciphertext may converted into the form that can be manually input and input into the server 108, 405, 600, 705 using a keyboard, may be converted into the form that can be manually input, recognized by a camera or character recognizer, and input into the server 108, 405, 600, 705, or may be converted into the QR code form, recognized by a QR code scanner, and input into the server 108, 405, 600, 705.

According to an embodiment of the disclosure, the verification information may include at least one of a receipt number assigned to the electronic device 101, the user terminal 401, 500, 701 when the electronic device 101, the user terminal 401, 500, 701 is sold, a center code of a service center to which a service center terminal 703, 800 belongs, an employee number of a service center employee 702, a manufacturing number of the electronic device 101, the user terminal 401, 500, 701, and a model name of the electronic device 101, the user terminal 401, 500, 701.

According to an embodiment of the disclosure, the ciphertext and the verification information may be input into the server 108, 405, 600, 705 through at least one of a tool installed on a service center terminal 703, 800 and a web page of the server 108, 405, 600, 705.

According to an embodiment of the disclosure, a server 108, 405, 600, 705 may include a communication interface 610 configured to receive a ciphertext for initialization of a password of a BIOS of the electronic device 101, the user terminal 401, 500, 701 and verification information to verify the initialization request, and a processor 630 configured to verify the initialization request by comparing the verification information with pre-enrolled information, and generate a decrypted string by decrypting the ciphertext using a prestored private key 470, 770, 915 according to the verification result, wherein the communication interface 610 may output the decrypted string.

According to an embodiment of the disclosure, the processor 630 may request a database 707 storing and managing pre-enrolled information corresponding to the electronic device 101, the user terminal 401, 500, 701 to search for a receipt number included in the verification information, and the communication interface 610 may receive the found pre-enrolled information corresponding to the receipt number from the database 707.

According to an embodiment of the disclosure, the processor 630 may output an error code when the search result shows that the receipt number or the pre-enrolled information corresponding to the receipt number is not found in the database 707 or when the verification fails according to a comparison result showing that the verification information and the pre-enrolled information do not match.

According to an embodiment of the disclosure, the processor 630 may request the database 707 to search for the receipt number in a URL form.

According to an embodiment of the disclosure, an operation method of a system including the electronic device 101, the user terminal 401, 500, 701, a service center terminal 703, 800, and a server 108, 405, 600, 705 may include operation 1110 of receiving, by the electronic device 101, the user terminal 401, 500, 701, a user input requesting initialization of a password of a BIOS of the electronic device 101, the user terminal 401, 500, 701, operation 1120 of generating, by the electronic device 101, the user terminal 401, 500, 701, a ciphertext by encrypting a predetermined length of random string using a public key 430, 730, 905 of the server 108, 405, 600, 705 prestored in the BIOS, in response to the user input, operation 1130 of transmitting, by the service center terminal 703, 800, the ciphertext and verification information to verify the initialization request to the server 108, 405, 600, 705, operation 1140 of verifying, by the server 108, 405, 600, 705, the initialization request using the verification information, operation 1150 of outputting, by the server 108, 405, 600, 705, a decrypted string by decrypting the ciphertext using a prestored private key 470, 770, 915 based on whether the verification is successful, and operation 1160 of initializing, the electronic device 101, the user terminal 401, 500, 701, the password of the BIOS according to whether a second hash value for the decrypted string and a first hash value for the random string match.

According to an embodiment of the disclosure, the operating method of the system may further include converting, by the electronic device 101, the user terminal 401, 500, 701, the ciphertext into a form that can be manually input or a QR code form and outputting the ciphertext to a screen of the electronic device 101, the user terminal 401, 500, 701, and the transmitting by the service center terminal 703, 800 to the server 108, 405, 600, 705 may include at least one of transmitting the ciphertext stored in the form of a file in the electronic device 101, the user terminal 401, 500, 701 to the server 108, 405, 600, 705, transmitting the ciphertext converted into the form that can be manually input into the server 108, 405, 600, 705 through a keyboard input, recognizing the ciphertext converted into the form that can be manually input using a camera or character recognizer and transmit the ciphertext to the server 108, 405, 600, 705, and recognizing the ciphertext converted into the QR code form using a QR code scanner and transmit the ciphertext to the server 108, 405, 600, 705.

According to an embodiment of the disclosure, the transmitting by the service center terminal 703, 800 to the server 108, 405, 600, 705 may include transmitting the ciphertext and the verification information to the server 108, 405, 600, 705 through at least one of a tool installed on a service center terminal 703, 800 and a web page of the server 108, 405, 600, 705.

According to an embodiment of the disclosure, the verification information may include at least one of a receipt number assigned to the electronic device 101, the user terminal 401, 500, 701 when the electronic device 101, the user terminal 401, 500, 701 is sold, a center code of a service center to which a service center terminal 703, 800 belongs, an employee number of a service center employee 702, a manufacturing number of the electronic device 101, the user terminal 401, 500, 701, and a model name of the electronic device 101, the user terminal 401, 500, 701.

According to an embodiment of the disclosure, the verifying, by the server 108, 405, 600, 705, of the initialization request may include requesting a database 707 storing and managing pre-enrolled information corresponding to the electronic device 101, the user terminal 401, 500, 701 to search for a receipt number included in the verification information, receiving the found pre-enrolled information corresponding to the receipt number from the database 707, an replying to the service center terminal 703, 800 with an error code when the receipt number or the pre-enrolled information corresponding to the receipt number is not found in the database 707 or when even at least one item of the pre-enrolled information does not match the verification information.

According to an embodiment of the disclosure, the initializing, by the electronic device 101, the user terminal 401, 500, 701, of the password of the BIOS may include determining whether the first hash value and the second hash value match, repeatedly receiving the second hash value a preset number of times when the first hash value and the second hash value do not match, and generating a new random string when the second hash value received repeatedly does not match the first hash value.

According to an embodiment of the disclosure, the initializing, by the electronic device 101, the user terminal 401, 500, 701, of the password of the BIOS may further include generating a new random string when the second hash value received repeatedly does not match the first hash value.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A user terminal comprising:
an input interface configured to:
receive a user input requesting initialization of a password of a basic input output system (BIOS) of the user terminal, and
receive a decrypted string obtained by decrypting a ciphertext for the initialization in response to the initialization request being verified based on verification information from a server;
memory storing one or more computer programs; and
one or more processors communicatively coupled to the input interface and the memory,
wherein the one or more computer programs include computer-executable instructions that, when executed by the one or more processors individually or collectively, cause the user terminal to:
generate the ciphertext by encrypting a predetermined length of random string, in response to the user input, and
initialize the password of the BIOS according to whether a second hash value for the decrypted string and a first hash value for the random string match.

2. The user terminal of claim 1, wherein the one or more computer programs further include computer-executable instructions that, when executed by the one or more processors individually or collectively, cause the user terminal to:
generate the random string, generate the first hash value for the random string, and
generate the ciphertext using a public key of the server prestored in the BIOS.

3. The user terminal of claim 1, wherein the one or more computer programs further include computer-executable instructions that, when executed by the one or more processors individually or collectively, cause the user terminal to:
when the first hash value and the second hash value do not match,
initialize the password of the BIOS according to whether the second hash value received repeatedly a preset number of times through the input interface matches the first hash value.

4. The user terminal of claim 3, wherein the one or more computer programs further include computer-executable instructions that, when executed by the one or more processors individually or collectively, cause the user terminal to:
generate a new random string when the second hash value received repeatedly does not match the first hash value.

5. The user terminal of claim 1, wherein the one or more computer programs further include computer-executable instructions that, when executed by the one or more processors individually or collectively, cause the user terminal to:
convert the ciphertext into a form that can be manually input or a quick response (QR) code form and output the ciphertext to a screen of the user terminal.

6. The user terminal of claim 5, wherein the ciphertext:
is converted into the form that can be manually input and input into the server using a keyboard,
is converted into the form that can be manually input, recognized by a camera or character recognizer, and input into the server, or
is converted into the QR code form, recognized by a QR code scanner, and input into the server.

7. The user terminal of claim 1, wherein the verification information comprises at least one of a receipt number assigned to the user terminal when the user terminal is sold, a center code of a service center to which a service center terminal belongs, an employee number of a service center employee, a manufacturing number of the user terminal, or a model name of the user terminal.

8. The user terminal of claim 1, wherein the ciphertext and the verification information are input into the server through at least one of a tool installed on a service center terminal and a web page of the server.

9. A server comprising:
a communication interface configured to receive a ciphertext for initialization of a password of a basic input output system (BIOS) of a user terminal and verification information to verify the initialization request;
memory storing one or more computer programs; and
one or more processors communicatively coupled to the communication interface and the memory,
wherein the one or more computer programs include computer-executable instructions that, when executed by the one or more processors individually or collectively, cause the server to:
verify the initialization request by comparing the verification information with pre-enrolled information, and
generate a decrypted string by decrypting the ciphertext using a prestored private key according to the verification result,
wherein the communication interface is configured to output the decrypted string.

10. The server of claim 9,
wherein the one or more computer programs further include computer-executable instructions that, when executed by the one or more processors individually or collectively, cause the server to request a database storing and managing pre-enrolled information corresponding to the user terminal to search for a receipt number included in the verification information, and
wherein the communication interface is configured to receive found pre-enrolled information corresponding to the receipt number from the database.

11. The server of claim 10, wherein the one or more computer programs further include computer-executable instructions that, when executed by the one or more processors individually or collectively, cause the server to output an error code when a search result shows that the receipt number or the pre-enrolled information corresponding to the receipt number is not found in the database or when the verification fails according to a comparison result showing that the verification information and the pre-enrolled information do not match.

12. The server of claim 10, wherein the one or more computer programs further include computer-executable instructions that, when executed by the one or more processors individually or collectively, cause the server to request the database to search for the receipt number in a uniform resource locator (URL) form.

13. A method of operating a system comprising a user terminal, a service center terminal, and a server, the method comprising:
receiving, by the user terminal, a user input requesting initialization of a password of a basic input output system (BIOS) of the user terminal;
generating, by the user terminal, a ciphertext by encrypting a predetermined length of random string using a public key of the server prestored in the BIOS, in response to the user input;
transmitting, by the service center terminal, the ciphertext and verification information to verify the initialization request to the server;
verifying, by the server, the initialization request using the verification information;
outputting, by the server, a decrypted string by decrypting the ciphertext using a prestored private key based on whether the verification is successful; and
initializing, the user terminal, the password of the BIOS according to whether a second hash value for the decrypted string and a first hash value for the random string match.

14. The method of claim 13, wherein the verifying, by the server, of the initialization request comprises:
requesting a database storing and managing pre-enrolled information corresponding to the user terminal to search for a receipt number included in the verification information;
receiving found pre-enrolled information corresponding to the receipt number from the database; and
replying to the service center terminal with an error code when the receipt number or the pre-enrolled information corresponding to the receipt number is not found in the database or when even at least one item of the pre-enrolled information does not match the verification information.

15. The method of claim 13, wherein the initializing, by the user terminal, of the password of the BIOS comprises:
determining whether the first hash value and the second hash value match;
repeatedly receiving the second hash value a preset number of times when the first hash value and the second hash value do not match; and
generating a new random string when the second hash value received repeatedly does not match the first hash value.

16. The method of claim 13, further comprising:
converting the ciphertext into a form that can be manually input or a quick response (QR) code form and output the ciphertext to a screen of the user terminal;
converting the ciphertext into a form that can be manually input and input into the server using a keyboard;
converting the ciphertext into the form that can be manually input, recognized by a camera or character recognizer, and input into the server; or
converting the ciphertext into the QR code form, recognized by a QR code scanner, and input into the server.

17. The method of claim 13, wherein the verification information comprises at least one of a receipt number assigned to the user terminal when the user terminal is sold, a center code of a service center to which a service center terminal belongs, an employee number of a service center employee, a manufacturing number of the user terminal, or a model name of the user terminal.

18. The method of claim 13, further comprising:
inputting the ciphertext and the verification information into the server through at least one of a tool installed on a service center terminal and a web page of the server.

19. One or more non-transitory computer-readable storage media storing computer-executable instructions that, when executed by one or more processors individually or collectively, cause a system comprising a user terminal, a service center terminal, and a server to perform operations, the operations comprising:
receiving, by the user terminal, a user input requesting initialization of a password of a basic input output system (BIOS) of the user terminal;
generating, by the user terminal, a ciphertext by encrypting a predetermined length of random string using a public key of the server prestored in the BIOS, in response to the user input;
transmitting, by the service center terminal, the ciphertext and verification information to verify the initialization request to the server;
verifying, by the server, the initialization request using the verification information;
outputting, by the server, a decrypted string by decrypting the ciphertext using a prestored private key based on whether the verification is successful; and
initializing, the user terminal, the password of the BIOS according to whether a second hash value for the decrypted string and a first hash value for the random string match.

20. The one or more non-transitory computer-readable storage media of claim 19, wherein the verifying, by the server, of the initialization request comprises:
requesting a database storing and managing pre-enrolled information corresponding to the user terminal to search for a receipt number included in the verification information;
receiving found pre-enrolled information corresponding to the receipt number from the database; and
replying to the service center terminal with an error code when the receipt number or the pre-enrolled information corresponding to the receipt number is not found in the database or when even at least one item of the pre-enrolled information does not match the verification information.
